(19) United States
(12) Patent Application Publication
(10) Pub. No.: US 2012/0005838 A1
(43) Pub. Date: Jan. 12, 2012

(54) CORK REMOVAL AND WRITING IMPLEMENT DEVICE

(76) Inventor: Nancy Ellington, Swannanoa, NC (US)

(21) Appl. No.: 12/833,364

(22) Filed: Jul. 9, 2010

(51) Int. Cl. B67B 7/44; B25F 1/04

(52) U.S. Cl. 7/155; 7/156

(57) ABSTRACT

A combination cork puller and writing pen device is provided having a hand grip, a writing pen, the writing pen being movably mounted in the hand grip and movable between a retracted position and an extended position, and a corkscrew-shaped cork pulling tool, the cork pulling tool being movably mounted in the hand grip and movable between a folded-up position and a cork pulling position. The device also includes a leverage brace movable between a folded-up position and a bottle neck engaging position in which the leverage brace can be placed against the top of a neck of a bottle to operate as a leverage support while the hand grip is raised, thereby bringing about a lifting motion of the cork pulling tool along with a cork that has been engaged by the cork pulling tool.

### BACKGROUND OF THE INVENTION

The present invention relates to a cork removal and writing implement device and, more particularly, to a device having a spiral tool, a cork pulling leverage brace, and a retractable writing implement.

One category of corkscrews are available under many brand names and these type of corkscrews all include a hand grip portion and a spiral tool pivotally connected to the hand grip portion and pivotable between a folded-up condition in which the spiral tool is folded parallel to the longitudinal extent of the hand held portion and a cork removal condition in which the spiral tool has been unfolded to a perpendicular orientation relative to the hand held portion. With the spiral tool located perpendicular to the operating lever and the sharp tip of the spiral tool engaging the top of a bottle cork to be removed, the spiral tool is rotated at the same time as downward pressure is applied, until the spiral tool has penetrated to a sufficient distance in the stopper. In the case of certain known corkscrews, a leverage brace is provided that is also pivotally connected to the hand held portion and, after penetration of the spiral tool into the cork or stopper, the free end of the leverage brace is placed in engagement with the edge of the bottle neck and the hand held portion is pivoted relative to the leverage brace. This action causes the spiral tool to be drawn upwardly by the hand held portion and the spiral tool, still engaging the cork or stopper, draws the cork or stopper out of the bottle neck.

Bottles of wine and other alcoholic beverages are served in many restaurants and it is customary for a waiter or waitress to attend to removal of a cork or stopper from the bottle and pour the wine or beverage into glasses. It can be understood that a corkscrew that can be folded into a more compact configuration is useful and convenient for waiters and waitresses. While such corkscrews may provide convenience in use and can be readily carried in a pocket or on a key ring, it remains that waiters and waitresses must also attend to customary wait staff tasks such as writing the menu choices of the restaurant guests onto a paper order pad. Thus, there are benefits in convenience and usefulness that could be realized if a cork removal device were available that provides multiple functions beyond the removal of a cork or stopper from a bottle, and, in particular, provides functions that assist a waiter or waitress in performing other customer service tasks such as writing the menu choices of the restaurant guests onto a paper order pad. According to U.S. Pat. No. 6,032,553 to Puig et al, in hotel or restaurant work, staff, especially waiters and other employees who directly serve customers, must be equipped with tools and utensils that occupy as little space as possible and which, in turn, have features to carry out different operations, all of which are related to each other in their basic aspect; utensils which, in addition, ensure that their main function can be carried out simply and with a minimum of necessary effort.

### SUMMARY OF THE INVENTION

It is therefore an object of the present invention to provide a device that provides a function for the removal of a cork or stopper from a bottle and also provides at least one other function that assists a waiter or waitress in performing other customer service tasks such as writing the menu choices of the restaurant guests onto a paper order pad.

It is an object of the present invention to provide a device that permits a waiter or waitress to write customer orders using an ink pen as well as perform traditional bottle uncorking tasks, all with a single, easy-to-carry item.

The present invention is directed to a device having a hand grip to which are secured a spiral tool, and a combination bottle cap opener/leverage arm and additionally having a new feature in the form of a retractable ink pen. A foil cutting knife that can be optionally provided is operable to slit the foil covering the cork of, for example, a wine bottle, and the spiral tool and the combination bottle cap opener/leverage arm cooperate with one another for extracting the cork from the bottle. The retractable ink pen preferably includes a pen tip that can be extended from one end of the handle portion and retracted into the handle portion when not in use. This multi-function device thus permits a waiter or waitress to write customer orders using the ink pen as well as perform traditional bottle uncorking tasks, all with a single, easy-to-carry item.

According to one aspect of the present invention, a combination cork puller and writing pen device is provided having a hand grip, a writing pen, the writing pen being movably mounted in the hand grip and movable between a retracted position and an extended position, and a corkscrew-shaped cork pulling tool, the cork pulling tool being movably mounted in the hand grip and movable between a folded-up position and a cork pulling position. The device also includes a leverage brace movable between a folded-up position and a bottle neck engaging position in which the leverage brace can be placed against the top of a neck of a bottle to operate as a leverage support while the hand grip is raised, thereby bringing about a lifting motion of the cork pulling tool along with a cork that has been engaged by the cork pulling tool.

According to another aspect of the present invention, a device is provided having a base portion, a writing implement, a spiral tool, a tool connector for connecting the spiral tool and the base portion to one another, a leverage brace, and a brace connector. The base portion has a lengthwise axis, a width axis, and a periphery, the length axis and the width axis together defining a reference plane. The writing implement has a writing tip for disposing an ink or other transferable substance onto a surface, and is movably mounted on the base portion such that the writing implement can be moved between a transfer position in which the writing implement extends beyond the periphery of the base portion and a non-transfer position in which the writing implement is either not extended beyond the periphery of the base portion or, at most, is extended beyond the periphery of the base portion to a lesser extent than in the transfer position of the writing implement. The spiral tool is operable to engage a cork or stopper via a penetrating movement of the spiral tool into the cork or stopper and the spiral tool has a leading end that is the leading portion of the spiral tool in the cork or stopper as the spiral tool penetrates the cork or stopper. A tool connector for connecting the spiral tool and the base portion to one another is such that the spiral tool can be moved relative to the base portion between a stopper engaging position in which the leading end of the spiral tool is at a given depth spacing from the reference plane of the base portion as measured transversely to the reference plane and a carry position in which the leading end of the spiral tool is at a lesser depth spacing from the reference plane of the base portion than in the stopper engaging position of the spiral tool. The leverage brace has a distal end and a proximate end and a brace connector for connecting the proximate end of the leverage brace and the base portion to one another in a manner such that the leverage brace can be moved relative to the base portion between a bottle neck engaging position in which the distal end of the leverage brace is at a given depth spacing from the reference plane of the base portion and a carry position in which the distal end of the leverage brace is at a lesser depth spacing from the reference plane of the base portion than in the bottle neck engaging position of the leverage brace. The tool connector of the spiral tool is axially intermediate the writing tip of the writing implement and the brace connector of the leverage brace relative to the lengthwise axis of the base portion. The writing tip of the writing implement, in the transfer position of the writing implement, and the leading end of the spiral tool, in the bottle engaging position of the spiral tool, are on the same one predetermined side of the reference plane of the base portion, and the periphery of the base portion includes a set back portion that is axially intermediate the writing tip of the writing implement The transfer position of the writing implement, and the tool connector of the spiral tool relative to the lengthwise axis of the base portion is at a lesser depth spacing from the reference plane of the base portion than both the depth spacing of the writing tip of the writing implement in the transfer position of the writing implement and the depth spacing of the penetrating end of the spiral tool in the bottle engaging position of the spiral tool, as measured in the direction of the one predetermined side of the reference plane of the base portion.

### BRIEF DESCRIPTION OF THE DRAWINGS

FIG. 1 is a perspective view of one embodiment of the cork removal and writing implement device of the present invention;

FIG. 2 is a front elevational view of the one embodiment of the cork removal and writing implement device of the present invention shown in FIG. 1;

FIG. 3 is a front elevational view of another embodiment of the cork removal and writing implement device of the present invention;

FIG. 4 is a front elevational view of a portion of the another embodiment of the cork removal and writing implement device of the present invention shown in FIG. 3;

FIG. 5 is a front elevational view of the another embodiment of the cork removal and writing implement device of the present invention shown in FIG. 3 disposed in a hand of a person;

FIG. 6 is a front sectional view of a pen suitable for use as the writing implement of the cork removal and writing implement device of the present invention, showing the tip of the pen in an extended position;

FIG. 7 is a front sectional view of a portion of the pen shown in FIG. 6, showing the tip of the pen in a retracted position;

FIG. 8 is a fragmentary elevation view of the projection on the cartridge being engaged by the spring during the process of assembly;

FIG. 9 is a sectional view along the line IX-IX of FIG. 6;

FIG. 10 is an elevation view on an enlarged scale of the inner side of the clip, showing the method of securing to it the finger which has a cross slot for engaging the cartridge projection;

FIG. 11 is a three dimensional view of the slotted sleeve which receives the cartridge projection and showing the long slot in which the projection normally reciprocates;

FIG. 12 is a perspective view of an enhancement that can be provided for the cork removal and writing implement device of the present invention, whereby the writing function of the cork removal and writing implement device can be automatically suppressed in the event that the cork or stopper removal function of the cork removal and writing implement device is to be deployed, showing the spiral tool deployed in its stopper removal position; and

FIG. 13 is a perspective view of the enhancement shown in FIG. 12, showing the spiral tool disengaged from a driven gear of the enhancement, whereby the spiral tool can be moved from its stopper removal position.

### DETAILED DESCRIPTION OF AN EMBODIMENT

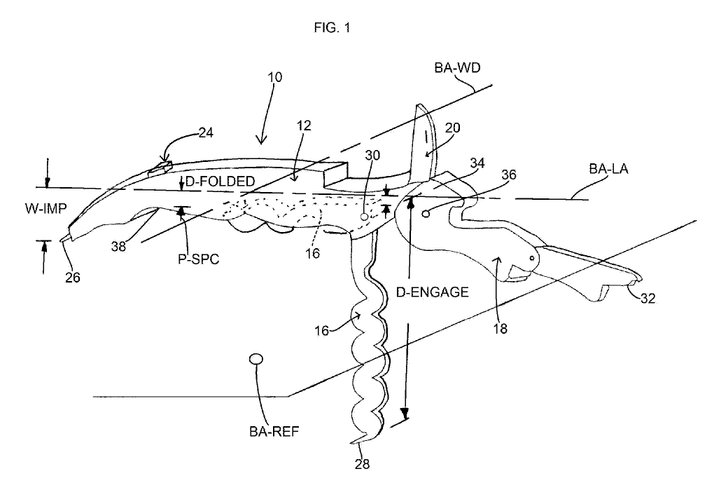

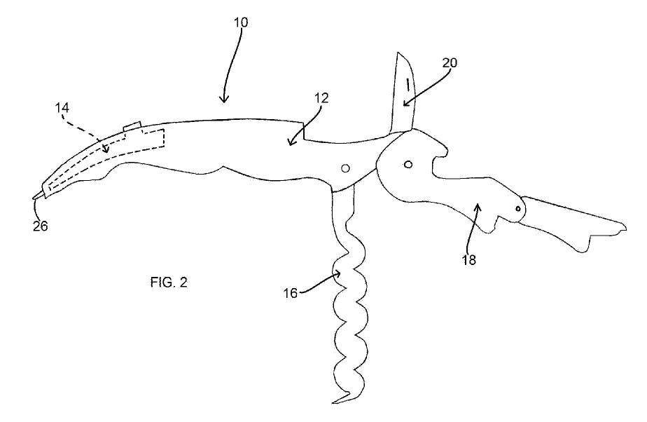

With reference now to FIG. 1, which is a perspective view of one embodiment of the cork removal and writing implement device of the present invention, and FIG. 2, which is a front elevational view of the one embodiment of the cork removal and writing implement device of the present invention shown in FIG. 1, a cork removal and writing implement device in the form of a “print/pull” device 10 includes a base portion 12, a writing implement 14, a spiral tool 16, a leverage brace 18, and a foil cutter blade 20. The print/pull device 10 is operable as a multi-function “waiter's tool” that, for example, permits a waiter or waitress in a restaurant to write customer orders using the writing implement 14 as well as perform traditional bottle uncorking tasks with the spiral tool 16, the leverage brace 18, and the foil cutter blade 20, all with a single, easy-to-carry configuration.

The base portion 12 preferably has an ergonomically favorable hand grip portion 22 that facilitates a lifting function performed by the base portion 12 and, additionally, facilitates manual gripping of the base portion 12 when the writing implement 14 is deployed, as will be described in more detail herein. The base portion 12 has a lengthwise axis BA-LA and a width axis BA-WD and a periphery 24 of the base portion 12 can be defined relative to the lengthwise axis BA-LA and the width axis BA-WD. The lengthwise axis BA-LA and the width axis BA-WD together define a reference plane BA-REF.

The writing implement 14 has a writing tip 26, as seen in FIG. 2, that is operable to dispose an ink or other transferable substance onto a surface, such as, for example, a surface of a paper order pad (not shown) on which a person may record a customer's order in a restaurant. The writing implement 14 is movably mounted on the base portion 12 such that the writing implement 14 can be moved between a transfer position in which the writing implement 14 extends beyond the periphery 24 of the base portion 12 and a non-transfer position in which the writing implement 14 is either not extended beyond the periphery 24 of the base portion 12 or, at most, is extended beyond the periphery 24 of the base portion 12 to a lesser extent than in the transfer position of the writing implement 14.

The spiral tool 16 is operable to engage a cork or stopper (not shown) via a penetrating movement of the spiral tool 16 into the cork or stopper. As will be described in further detail herein, the spiral tool 16 in combination with the leverage brace 18 and the foil cutter knife 20 is particularly suitable for removing a cork or a stopper of a bottle such as a wine bottle that has a foil-covered cork or stopper. The spiral tool 16 has a leading end 28 that is the leading portion of the spiral tool 16 in the cork or stopper as the spiral tool 16 penetrates the cork or stopper.

The print/pull device 10 includes a tool connector 30 in the form of a hinge pin fixedly secured to the base portion 12 and extending parallel to the reference plane BA-REF. The tool connector 30 is operable to connect the spiral tool 16 and the base portion 12 to one another such that the spiral tool 16 can be moved relative to the base portion 12 between a stopper engaging position in which the leading end 28 of the spiral tool is at a given depth spacing D-ENGAGE from the reference plane BA-REF of the base portion 12 as measured transversely to the reference plane BA-REF (see solid line illustration of the spiral tool 16 shown in FIG. 1) and a carry position in which the leading end 28 of the spiral tool 16 is at a lesser depth spacing D-FOLDED from the reference plane BA-REF of the base portion 12 than in the stopper engaging position of the spiral tool 16 (see broken line illustration of a portion of the spiral tool 16 shown in FIG. 1).

The leverage brace 18 has a distal end 32, a proximate end 34, and a brace connector 36 in the form of a hinge pin fixedly secured to the base portion 12 for connecting the proximate end 34 of the leverage brace 18 and the base portion 12 to one another in a manner such that the leverage brace 18 can be moved relative to the base portion 12 between a bottle neck engaging position in which the distal end 32 of the leverage brace 18 is at a given depth spacing from the reference plane BA-REF of the base portion 12 and a carry position in which the distal end 32 of the leverage brace 18 is at a lesser depth spacing from the reference plane BA-REF of the base portion 12 than in the bottle neck engaging position of the leverage brace 18.

The tool connector 30 of the spiral tool 16 is axially intermediate the writing tip 26 of the writing implement 14 and the brace connector 36 of the leverage brace 18 relative to the lengthwise axis BA-LA of the base portion 12. The writing tip 26 of the writing implement 14, in the transfer position of the writing implement 14, and the leading end 28 of the spiral tool 16, in the bottle engaging position of the spiral tool 16, are on the same one predetermined side of the reference plane BA-REF of the base portion 12. For example, as seen in FIG. 2, The writing tip 26 of the writing implement 14, in the transfer position of the writing implement 14, and the leading end 28 of the spiral tool 16, in the bottle engaging position of the spiral tool 16, are on the same one predetermined side of the reference plane BA-REF of the base portion 12—namely, both the writing tip 26 of the writing implement 14 and the leading end 28 of the spiral tool 16 are below the reference plane BA-REF of the base portion 12, as viewed in FIG. 2. As seen in FIG. 2, the periphery 24 of the base portion 12 includes a set back portion 38 that is axially intermediate the writing tip 26 of the writing implement 14, in the transfer position of the writing implement 14, and the tool connector 30 of the spiral tool 16, relative to the lengthwise axis BA-LA of the base portion 12, and is at a lesser depth spacing P-SPC from the reference plane BA-REF of the base portion 12 than both the depth spacing W-IMP of the writing tip 26 of the writing implement 14 in the transfer position of the writing implement 14 and the depth spacing D-ENGAGE of the leading end 28 of the spiral tool 16 in the bottle engaging position of the spiral tool 16, as measured in the direction of the one predetermined side of the reference plane BA-REF of the base portion 12.

To use the print/pull device 10 as a writing implement, a person need only place the writing implement 14 in its transfer position in which the writing tip 26 extends beyond the periphery 24 of the base portion 12. After a writing task is completed, the person can move the writing implement 14 from its transfer position into its non-transfer position. To use the print/pull device 10 to remove a cork or stopper, a person moves the spiral tool 16 from its carry position in which the spiral tool extends generally parallel to the lengthwise axis BA-LA of the base portion 12 into its stopper engage position in which the spiral tool has been unfolded to a perpendicular orientation relative to the reference plane BA-REF of the base portion 12. The leading end 28 of the spiral tool 16 is then engaged with the top of the cork or stopper and the spiral tool 16 is rotated at the same time as downward pressure is applied, until the spiral tool 16 has penetrated to a sufficient distance in the cork or stopper such that the cork or stopper will be entrained with the spiral tool as the spiral tool is lifted. The distal end 32 of the leverage brace 18 is placed in engagement with the edge of the neck of the bottle in which the cork or stopper is lodged and the base portion 12 is pivoted relative to the leverage brace 18. This action causes the spiral tool 16 to be lifted and the spiral tool, still engaging the cork or stopper, draws the cork or stopper out of the bottle neck.

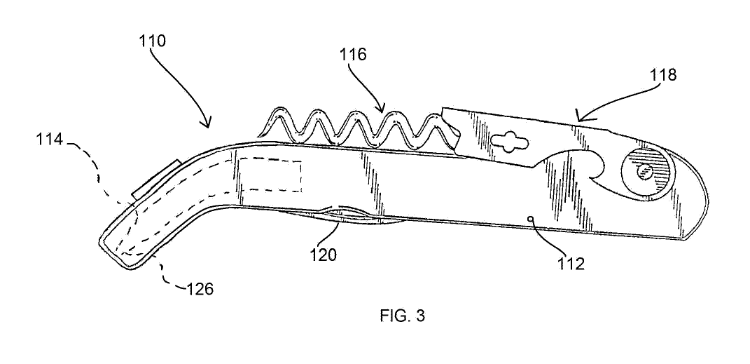

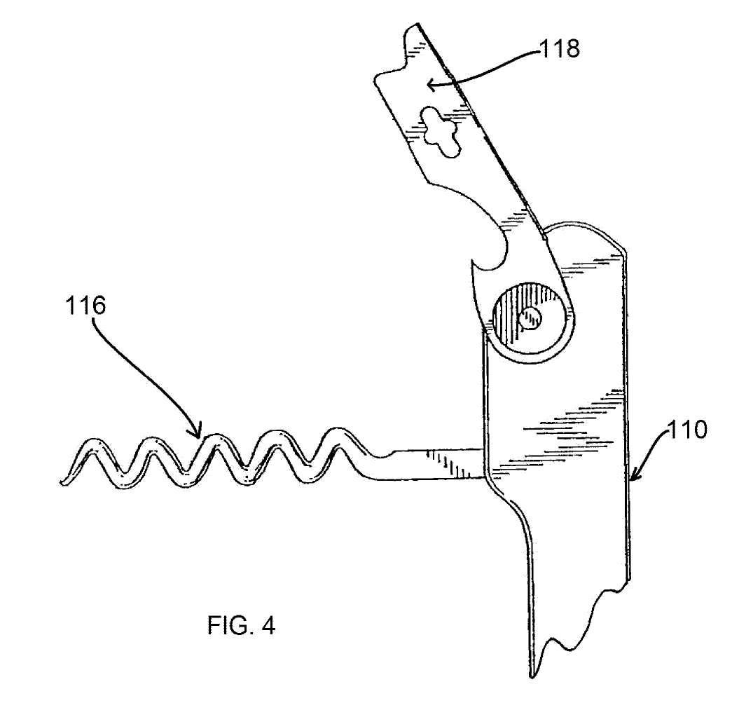

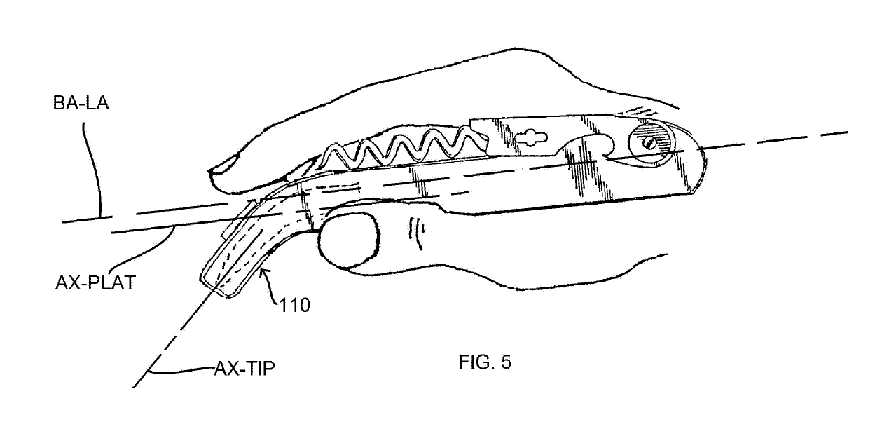

With reference now to FIGS. 3, 4, and 5, another embodiment of the cork removal and writing implement device of the present invention will now be described, and the cork removal and writing implement device, generally designated as the print/pull device 110, includes a base portion 112, a writing implement 114, a spiral tool 116, a leverage brace 118, and a foil cutter knife 120. The print/pull device 110 is operable as a multi-function “waiter's tool” that, for example, permits a waiter or waitress in a restaurant to write customer orders using the writing implement 114 as well as perform traditional bottle uncorking tasks with the spiral tool 116, the leverage brace 118, and the foil cutter knife 120 all with a single, easy-to-carry configuration. FIG. 3, which is a front elevational view of the print/pull device 110, shows the spiral tool 116 in its carry position, the leverage brace 118 in its carry position, and the foil cutter knife 120 in its carry position in which the single sharp edge of the knife is fully recessed into the base portion 112. FIG. 4, which is a front elevational view of a portion of the print/pull device 110, shows the spiral tool 116 in its stopper engage position and the leverage brace 118 no longer in its carry position but instead in a ready position from which the leverage brace 118 can be moved to engage the top of the neck of a bottle in the bottle neck engaging position of the leverage brace. FIG. 5, which is a front elevational view of the print/pull device 110 disposed in a hand of a person, shows the spiral tool 116 in its carry position and the leverage brace 118 in its carry position (the foil cutter knife 120 in its carry position as well but the foil cutter knife 120 is not visible in FIG. 5) and it can be seen that the writing implement 114 is in its non-transfer position in which the tip of the writing implement does not extend outwardly of the periphery of the base portion 112.

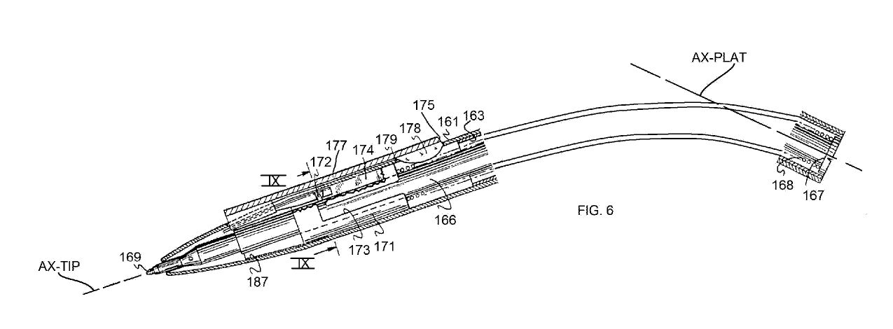

Reference is now had to FIGS. 6-11, which illustrate an exemplary configuration of a pen 160 suitable for use as the writing implement 14 of the one embodiment of the cork removal and writing implement device of the present invention shown in FIGS. 1 and 2 or as the writing implement 114 of the another embodiment of the cork removal and writing implement device of the present invention shown in FIGS. 3-5. FIG. 6 is a sectional front elevational view of the pen 160 reference is now had as well to FIG. 5, which shows the print/pull device 110, for an example of a deployment of the pen 160 as the writing implement 114 of the print/pull device 110. The pen 160 is configured to be housed in the base portion 112. In this regard, the base portion 112 has a curved end portion and the pen 160 is configured such that the pen has a corresponding curvature along its extent between the respective end of the pen through which ink exits the pen—i.e., the respective end of the pen forming the tip 126 of the writing implement 114—and the other end of the pen which is a closure platform. The tip 126 of the writing implement 114 lies on an axis AX-TIP that forms an acute angle with the lengthwise axis BA-LA while the closure platform of the pen lies on an axis AX-PLAT that is parallel to the lengthwise axis BA-LA. The pen 160 has an upper barrel 161 and a lower barrel 162 both frictionally engaging each other by means of an internal tubular connector 163 and an ornamental ring 164 may separate these two barrel portions. Reciprocating within the tube barrel portions is a cartridge 166 having a shoulder 167 against which a compression spring 168 bears to normally retract the writing tip 169. The shoulder 167 forms the closure platform of the pen 160. The upper end of the compression spring 168 bears against a slotted sleeve 171 frictionally held within the barrel 161 to maintain a stationary position. The cartridge 166 has a reduced diameter portion which has projecting therefrom a radial lug 172.

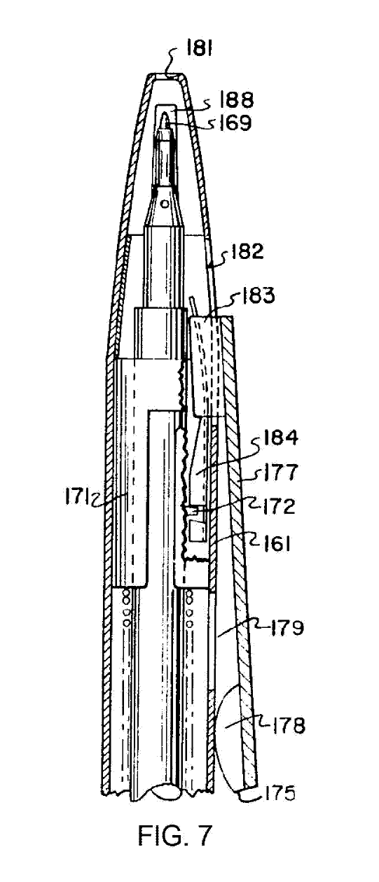

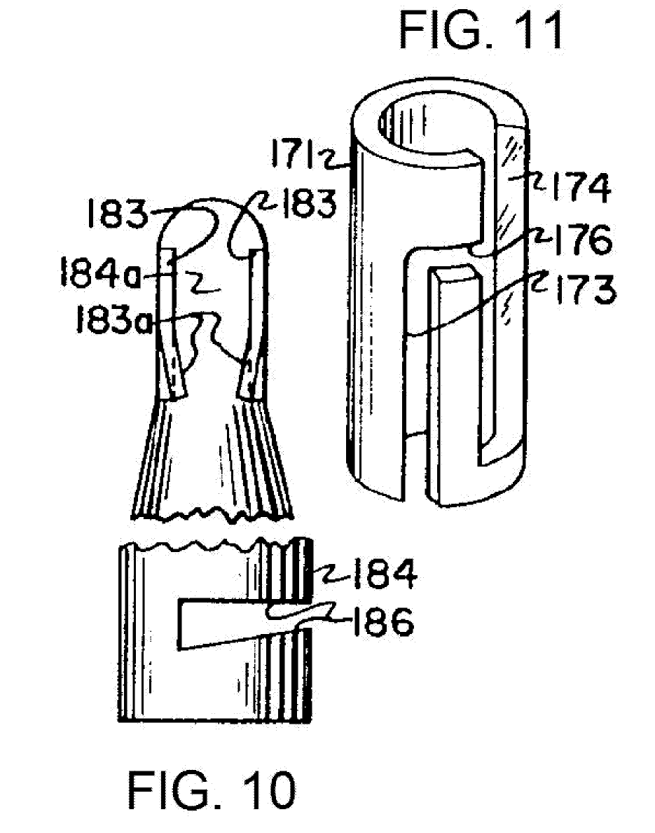

Referring particularly to FIG. 11, the sleeve 171 has bayonet slots formed therein, including a vertical slot 173 open from the bottom, a parallel vertical slot 174 open from the top, and a cross slot 176. When the cartridge 166 is inserted in the pen, the cap 162 is removed, and the projection 172 is pushed against the compression of spring 168 up the slot 173, and then is rotated to the right as viewed in FIG. 11 until the projection enters the vertical slot 174. The projection 172 on the cartridge normally reciprocates up and down in slot 174 as the cartridge is moved from a projected position illustrated in FIG. 10 to a tip retracted position shown in FIG. 7.

The pen is provided with the clip 177 having lower ball plates 178 that project through slots 179 formed in the barrel section 161. As shown best in FIG. 7, the lower end of the clip is formed at an inclined angle as at 175. The upper end of barrel 161 has an end hole 181 through which the writing tip 169 projects. The upper end of the barrel also has a pair of parallel slots 182 through which top plates 183 on the clip project. Secured to the inner end of these plates 183 is a vertical finger 184 which has a slot 186 into which the cartridge projection 172 is rotated. This finger 184 reciprocates in the vertical slot 174 in the sleeve 171. The clip plates 183 have a lower slit section 183a bent inwardly especially as shown in FIG. 10 to overlie portions of the finger 184 and thereby retain it in position on these plates. This retaining action is assisted by having a reduced section 184a at the region between the clip plates 183 best shown in FIG. 10.

The pen has closure members on the inside adjacent the tip hole 181, and these closure members have a tubular base 187, as seen in FIG. 6, from which project a pair of closure fingers 188, as seen in FIG. 7.

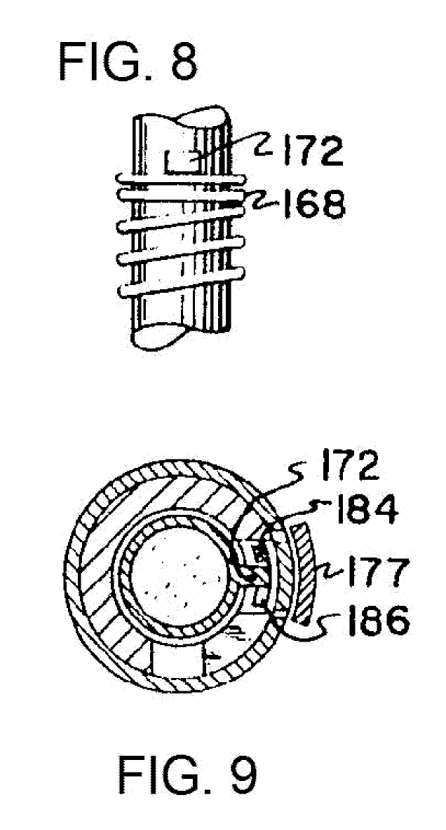

The method of assembly of the pen of FIGS. 6-11 is as follows. The tubular sleeve 171 is pushed into the lower barrel portion 162 and held there by friction. Thereafter the cartridge 166 has a spring fitted over it, as shown in FIG. 8. The compression spring will try to expand and will be held therefore between the projection 172, as shown in FIG. 8, and the cartridge shoulder 167 shown in FIG. 11. The assembly of spring and cartridge is then moved upwardly through the sleeve 171 and the projection 172 is fitted into the vertical slot 173. When the projection 172 reaches the end of this slot the cartridge is rotated about ninety degrees (90°), which disposes the projection in the vertical slot 174 (FIG. 11). At the time of this rotation the clip 177 is held in its upward position, as shown in FIG. 6, which disposes the slot 186 (FIG. 10) in the inner finger 184 opposite this transverse slot 176. The cartridge projection 172 then fits in this slot 186, as shown in FIG. 9. The compression of the spring 168 urges the projection 172 downwardly, as viewed in FIG. 6, and accordingly this downward urging combined with the slanted lower surface of the slot 186 (FIG. 10) insures that the projection will stay in the sleeve slot 174 and will not attempt to move into the transverse slot 176.

In operating the pen of FIGS. 6-11, if the writing tip 169 is retracted, as shown in FIG. 7, the user grasps, for example, the print/pull device 110 in a writing position as shown in FIG. 5, and then slides the clip toward the writing tip with the index finger. When the writing tip 169 is projected, the user continues the pressure of the index finger against the clip 177, causing the ball plates 178 to pass through the slots 179. The downward force of compression spring 168 drives the inclined end 175 against the bottom ends of slots 179 to lock the writing tip in the extended position shown in FIG. 6, thereby holding the clip 177 against the sliding motion. When the user is finished, the user presses the index finger against the upper end of clip 177 to rotate the ball plates 178 out and the compression spring thereupon takes over, retracting the writing tip 179 to its retracted position, shown in FIG. 7.

While the exemplary configuration of the pen 160 that has been described is suitable for use as the writing implement of the cork removal and writing implement device of the present invention, and this pen configuration includes the clip 177 for sliding retraction and extension of the writing tip 169, it is to be understood that other mechanisms can be provided in association the respective pen, ink-transferring element, or other print chemical element to provide for the retraction and extension functions. For example, the respective pen, ink-transferring element, or other print chemical element can be operatively coupled with a push button that can be depressed in a direction perpendicular to the reference plane BA-REF to effect retraction or extension of the writing tip of the respective pen, ink-transferring element, or other print chemical element.

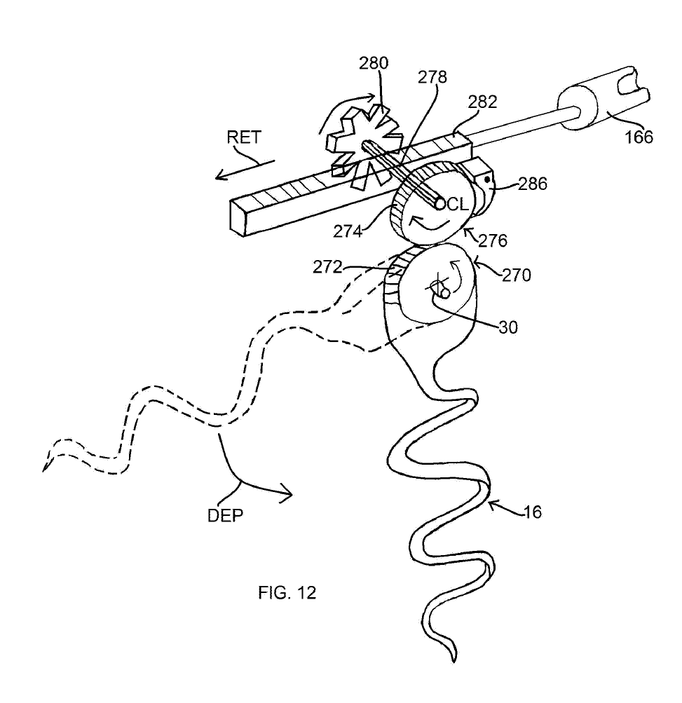

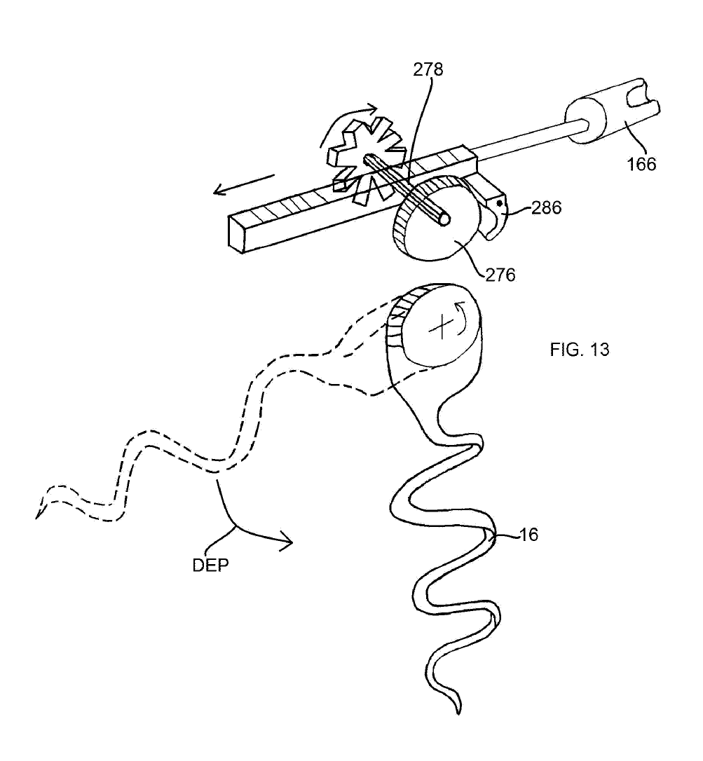

Reference is now had to FIGS. 12 and 13 for an illustration of an enhancement that can be provided for the cork removal and writing implement device of the present invention, whereby the writing function of the cork removal and writing implement device can be automatically suppressed in the event that the cork or stopper removal function of the cork removal and writing implement device is to be deployed. The print/pull device 10, for example, can be provided with this enhancement such that, as seen in FIG. 12, a movement of the spiral tool 16 between its carry position (shown in broken lines) and its stopper engaging position (shown in solid lines) will automatically effect a retraction of the writing tip 26 of the writing implement 14 to thereby place the writing implement into its non-transfer position. The spiral tool 116 has a head portion 270 that is pivotally mounted to the hinge pin 30 and has a plurality of drive gear teeth 272 arranged around the periphery of the head portion. The drive gear teeth 272 are in meshing gear with a plurality of driven gear teeth 274 of a driven gear 276 that is slidably mounted on a splined shaft 278. The splined shaft 278 is rotatably mounted in the base portion 12 and a pinion gear 280 of a rack and pinion assembly 282 is fixedly mounted to the splined shaft 278 at a spacing from the driven gear 276. The teeth of the pinion gear 280 of the rack and pinion assembly 282 mesh with the teeth of a rack 284 of the rack and pinion assembly 282 and one end of the rack 284 is coupled to the writing implement 14, whereupon, for example, if the writing implement 14 were configured as the pen 160, the rack 284 would be coupled to the cartridge 166. A pawl 286 engages the driven gear teeth 274 of the driven gear 276 and prevents the driven gear 276 from being rotated in a counter-clockwise direction while permitting rotation of the driven gear 276 in a clockwise direction CL.

It can be seen that a movement of the spiral tool 16 between its carry position (shown in broken lines) and its stopper engaging position (shown in solid lines) in a pivot direction DEP will effect a counter-clockwise rotation of the head portion 270 of the spiral tool 16, whereupon the drive gear teeth 272 of this head portion 270 will effect a clockwise rotation of the driven gear 276 in the clockwise direction CL. The clockwise rotation of the driven gear 276 will, in turn, effect a clockwise rotation of the pinion gear 280 that, in turn, drives the rack 284 in a retracting direction RET. The retracting movement of the rack 284 pulls the writing implement 14 from its transfer position to its non-transfer position. To instead execute a movement of the spiral tool 16 from its stopper engaging position (shown in solid lines) into its carry position (shown in broken lines), it can be seen in FIG. 13 that a user need only slide the driven gear 276 along the splined shaft 278 toward the pinion gear 282 to an extent such that the driven gear teeth 274 are no longer in meshing contact with the drive gear teeth 272 of the head portion 270 of the spiral tool 16 and then the user can freely pivot the spiral tool 16 is a reverse pivoting direction counter to the pivot direction DEP to place the spiral tool 16 in its carry position. The sliding displacement of the driven gear 276 along the splined shaft 278 toward the pinion gear 282 to an extent such that the driven gear teeth 274 are no longer in meshing contact with the drive gear teeth 272 of the head portion 270 of the spiral tool 16 ensures that the counter-clockwise pivoting of the spiral tool 16 does not bring about a deployment of the writing implement 14 into its transfer position. A biasing element such as, for example, a spring (not shown) located between, and pressing against, the pinion gear 280 and the driven gear 276 can be provided to automatically restore the driven gear 276 into its meshing engagement with the drive gear teeth 272 of the head portion 270 of the spiral tool 16 when an inward displacement force is no longer applied on the driven gear 276.

While an embodiment of the invention has been described and illustrated herein, it is to be distinctly understood that the invention is not limited thereto, but may be otherwise variously embodied and practiced within the scope of the following claims.

It is claimed:

1. A combination cork puller and writing pen device comprising:
a hand grip;
a writing pen, the writing pen being movably mounted in the hand grip and movable between a retracted position and an extended position;
a corkscrew-shaped cork pulling tool, the cork pulling tool being movably mounted in the hand grip and movable between a folded-up position and a cork pulling position; and
a leverage brace, the leverage brace being connected to the hand grip such that the leverage brace can be moved between a folded-up position and a bottle neck engaging position in which the leverage brace can be placed against the top of a neck of a bottle to operate as a leverage support while the hand grip is raised, thereby bringing about a lifting motion of the cork pulling tool along with a cork that has been engaged by the cork pulling tool.

2. The combination cork puller and writing pen device according to claim 1, wherein the hand grip has one end having a reduced thickness as compared to an opposite end of the hand grip and the writing pen is mounted in the reduced thickness end of the hand grip.

3. The combination cork puller and writing pen device according to claim 2, wherein the reduced thickness end of the hand grip has a predetermined curvature and the writing pen has a curvature corresponding to the predetermined curvature of the reduced thickness end of the hand grip.

4. The combination cork puller and writing pen device according to claim 3 and further comprising an assembly for automatically disposing the writing pen is in its retracted position in response to placing the cork pulling tool in its cork pulling position.

5. The combination cork puller and writing pen device according to claim 1 and further comprising a foil cutter knife.

6. A device comprising:
a base portion, the base portion having a lengthwise axis, a width axis, and a periphery, the length axis and the width axis together defining a reference plane;
a writing implement, the writing implement having a writing tip for disposing an ink or other transferable substance onto a surface, the writing implement being movably mounted on the base portion such that the writing implement can be moved between a transfer position in which the writing implement extends beyond the periphery of the base portion and a non-transfer position in which the writing implement is either not extended beyond the periphery of the base portion or, at most, is extended beyond the periphery of the base portion to a lesser extent than in the transfer position of the writing implement;
a spiral tool, the spiral tool being operable to engage a cork or stopper via a penetrating movement of the spiral tool into the cork or stopper and the spiral tool having a leading end that is the leading portion of the spiral tool in the cork or stopper as the spiral tool penetrates the cork or stopper;
a tool connector for connecting the spiral tool and the base portion to one another such that the spiral tool can be moved relative to the base portion between a stopper engaging position in which the leading end of the spiral tool is at a given depth spacing from the reference plane of the base portion as measured transversely to the reference plane and a carry position in which the leading end of the spiral tool is at a lesser depth spacing from the reference plane of the base portion than in the stopper engaging position of the spiral tool;
a leverage brace, the leverage brace having a distal end and a proximate end; and
a brace connector for connecting the proximate end of the leverage brace and the base portion to one another in a manner such that the leverage brace can be moved relative to the base portion between a bottle neck engaging position in which the distal end of the leverage brace is at a given depth spacing from the reference plane of the base portion and a carry position in which the distal end of the leverage brace is at a lesser depth spacing from the reference plane of the base portion than in the bottle neck engaging position of the leverage brace, the tool connector of the spiral tool is axially intermediate the writing tip of the writing implement and the brace connector of the leverage brace relative to the lengthwise axis of the base portion, the writing tip of the writing implement, in the transfer position of the writing implement, and the leading end of the spiral tool, in the bottle engaging position of the spiral tool, are on the same one predetermined side of the reference plane of the base portion, and the periphery of the base portion includes a set back portion that is axially intermediate the writing tip of the writing implement, in the transfer position of the writing implement, and the tool connector of the spiral tool relative to the lengthwise axis of the base portion and is at a lesser depth spacing from the reference plane of the base portion than both the depth spacing of the writing tip of the writing implement in the transfer position of the writing implement and the depth spacing of the penetrating end of the spiral tool in the bottle engaging position of the spiral tool, as measured in the direction of the one predetermined side of the reference plane of the base portion.

7. The device according to claim 6, wherein the base portion has one end having a reduced thickness as compared to an opposite end of the base portion and the writing implement is mounted in the reduced thickness end of the base portion.

8. The device according to claim 6, wherein the reduced thickness end of the base portion has a predetermined curvature and the writing implement has a curvature corresponding to the predetermined curvature of the reduced thickness end of the base portion.

9. The combination cork puller and writing pen device according to claim 6 and further comprising an assembly for automatically disposing the writing implement is in its non-transfer position in response to placing the spiral tool in its stopper engaging position.

10. The combination device according to claim 6 and further comprising a foil cutter knife.
